(19) United States
(12) Patent Application Publication
(10) Pub. No.: US 2013/0251905 A1
(43) Pub. Date: Sep. 26, 2013

(54) METHOD OF APPLYING THERMAL INK TO BEVERAGE CONTAINERS

(71) Applicant: Jason Morgan Kelly, Arvada, CO (US)

(72) Inventor: Jason Morgan Kelly, Arvada, CO (US)

(73) Assignee: MILLERCOORS, LLC, Golden, CO (US)

(21) Appl. No.: 13/429,084

(22) Filed: Mar. 23, 2012

(51) Int. Cl. B05D 5/00

(52) U.S. Cl. 427/256

(57) ABSTRACT

A method of applying thermal inks to beverage containers includes use of a selected printing process for transferring controlled and discreet amounts of thermal inks to pre-designated portions of a beverage container. In a preferred embodiment, thermal ink(s) are transferred to the opening tab of a metallic container. During manufacturing, the ink can be applied in registered print rows that align with a plurality of corresponding spaced rows of tabs formed in tab stock. Each of the opening tabs has a pre-selected pattern of the applied thermal ink that can be used as a temperature indicator for a beverage within the container. Applying thermal ink to the opening tabs as opposed to larger areas of the container on the sidewall results in reducing the amount of thermal ink used.

### FIELD OF THE INVENTION

The invention generally relates to methods of applying inks to containers such as beverage containers, and more specifically to methods of applying thermal inks to beverage containers in a controlled manner to reduce the amount of ink used, yet to employ use of the thermal inks to still sufficiently display temperature conditions of the containers.

### BACKGROUND OF THE INVENTION

There are numerous methods of applying indicia to a substrate such as a label of a container, as well as numerous methods of applying indicia directly to a container such as an aluminum can. Sophisticated printing techniques have developed over time allowing containers to employ very ornate and complex container designs.

For beverage containers, it is known to apply thermal or thermal/thermochromic ink to the container sidewalls. The thermal ink can be used as an indication of the temperature of the beverage within the container. More specifically, selected thermal inks applied to a container undergo a color change as the beverage changes temperature, and the color(s) displayed by the thermal inks correspond to a known temperature range. Accordingly, beverage containers may incorporate the use of thermal inks to convey information to the consumer as to the temperature of the beverage, and whether it is at an optimum temperature for consumption.

Examples of references that disclose the use of thermal inks on beverage containers include the U.S. Pat. Nos. 4,919,983; 5,400,610, and 7,556,425. Other references include the published U.S. Application Publication Nos. 20100308032, 2008084915, and 20030000451.

Although thermal inks provide a unique capability for conveying information to a consumer, thermal inks are relatively expensive as compared to other types of inks Furthermore, thermal inks are not easily applied with consistent thicknesses, especially for application upon smooth surfaces such as aluminum. In order to overcome problems associated with applying an adequate amount of thermal ink to a designated area of a container, the preferred practice has been to flood coat a significant portion of the container sidewall with the ink, and then to print over the thermal ink with the remaining portions of the label pattern and lettering.

Not only does the use of thermal ink materially increase the cost of manufacturing a container, but use of the thermal ink requires a separate printing step, and a time delay in order for the thermal ink to set prior to finishing the labeling of the container. Even with application of thermal ink to paper-based materials, the thermal ink is applied in a flood coat manner which covers a significant portion of the material, and the remaining printing of the label is then completed in a subsequent printing process.

Although thermal inks provide the capability of conveying temperature information to consumers, the disadvantages of using thermal ink make its use on many containers infeasible due to the increased cost associated with the use of the thermal inks Therefore, there is a need to provide thermal inks for containers in which the thermal ink may be incorporated in the container to adequately convey temperature information to a consumer, but significantly reducing the costs of using the thermal inks

### SUMMARY

In accordance with a method of the present invention, in one aspect of the invention, a method is provided to apply thermal inks to discrete portions of a container without the requirement for flood coating a larger continuous area of the container.

In another aspect of the invention, the method includes applying ink to portions of the container other than the sidewall of the container, namely, the opening tab of the container mounted to the top surface or end of the container.

In yet another aspect of the invention, thermal ink is applied to the opening tab of the container in a selected amount and on a pre-designated area of the tab, which therefore limits the amount of thermal ink used, yet still provides an adequate color indication corresponding to the temperature of the beverage.

In yet another aspect of the invention, the method includes calculating an ambient temperature offset that ensures the color displayed to a consumer corresponds to the estimated temperature of the beverage. More specifically, since the opening tab has a significant portion of its area that is not in direct contact with the container, ambient temperatures will more greatly affect the temperature of the exposed surface of the opening tab that has thermal ink applied thereto. Therefore, an offset calculation may be made which takes into consideration how quickly ambient temperature conditions may affect the temperature of the opening tab after it has been removed from a controlled temperature environment such as a refrigerator.

Among the many advantages of the invention, which will be made more apparent by a review of the following detailed description of the drawings, provision of a thermal ink on a container is provided that not only reduces the amount of the thermal ink used on the container, but still provides a convenient temperature indicator for the consumer. Another advantage of applying thermal ink to the opening tab is that the opening tab is a portion of the container that the consumer routinely views when opening the container, which therefore provides a convenient location for the user to also view an indication of the temperature of the container.

### BRIEF DESCRIPTION OF THE DRAWINGS

FIG. 1 is a schematic diagram of a prior art printing process in which an ink such as thermal ink is applied as a flood coating to a material;

FIG. 2 is a schematic diagram of a printing process that is capable of applying thermal ink in registered or pre-designated print rows to achieve the method of the invention;

FIG. 3 is another schematic view of a printing process that can be used to achieve the method of the present invention;

FIG. 4 is a plan view of a strip of metal, namely, metal stock that had been pre-cut or pre-stamped in three rows of elements for use as opening tabs of containers, and further showing thermal ink applied in the registered print rows corresponding to rows of the opening tabs formed on the tab stock;

FIG. 5 is an enlarged fragmentary perspective view of an example gravure cylinder that can be used with a selected printing method to create the registered print rows for applying to a selected material such as the tab stock; and

FIG. 6 is a plan view of a container end incorporating an opening tab coated/printed with a selected thermal ink(s).

### DETAILED DESCRIPTION

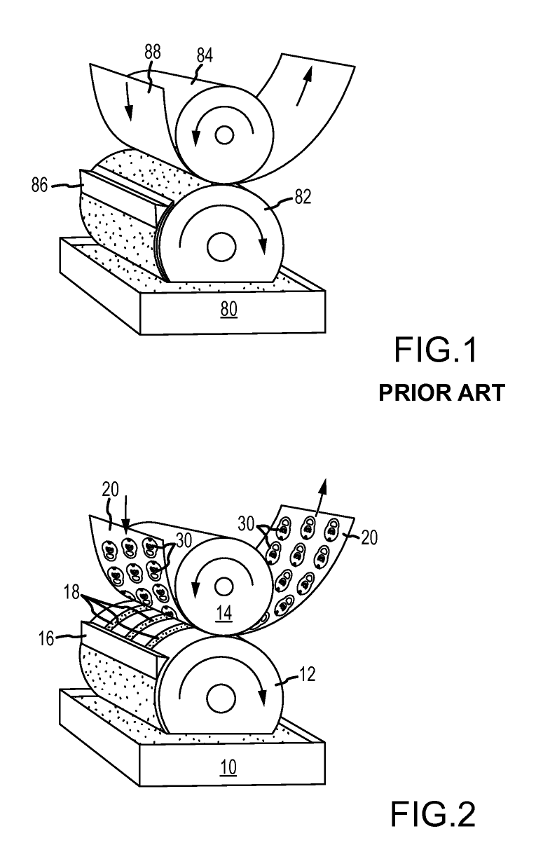

Referring to FIG. 1, a prior art method is illustrated for applying an ink, such as thermal ink, to a material. More specifically, the schematic of FIG. 1 illustrates an ink source 80 that communicates with a transfer cylinder 82 that transfers ink from the cylinder 82 to a strip of material 88 which is progressively moved by a driving roller 84. As shown, the strip of material 88 is positioned between the transfer roller 82 and the drive roller 84, and the ink is uniformly transferred in a flood coating from the transfer roller 82 to the side of the material that faces and contacts the transfer roller 82. A doctor blade 86 is used to limit or otherwise control the amount of ink that is transferred to the material 88 by adjusting the amount of pressure applied by the doctor blade to the exposed printing surface of the transfer roller 82. As one can appreciate by reviewing the FIG. 1, the flood coating of ink across substantially all of the surface of the material 88 results in use of a significant amount of thermal ink.

Referring to FIG. 2, an example printing process is shown for a first preferred embodiment of the method of the present invention. In this example, thermal ink is applied by a rotogravure or engraving printing process. The schematic diagram of FIG. 2 is similar to what is shown in the prior art of FIG. 1; however, the manner in which the ink is transferred to the material is achieved by small engravings or recesses/indentations formed on the gravure cylinder 12.

More specifically, the FIG. 2 illustrates a source of ink 10, the gravure cylinder 12, and an impression cylinder or roller 14. A doctor blade 16 is also used for controlling an amount of the ink to remain on the cylinder 12. Registered or aligned print rows 18 are formed after contact of the doctor blade 16 with the exposed surface of the gravure cylinder 12. That is, the doctor blade 16 wipes off the ink from the roller 12 except for the engraved or recessed portions of the cylinder that hold ink. Referring also to FIG. 5, the gravure cylinder 12 is shown with three engravings or recesses that, when filled with ink, form the registered print rows 18. The remaining portions 24 of the exposed surface of the gravure cylinder, after rotating past the doctor blade 16, have no observable amounts of ink which remain on the portions 24 because the doctor blade is preferably positioned to effectively scrape or wipe off substantially all of the ink from the portions 24. Therefore, the resulting registered print rows 18 with ink therein come into contact with the material 20 via the impression roller 14 which places a designated amount of force against the material 20 to contact the registered print rows 18 on the gravure cylinder 12. The resulting application of the thermal ink is therefore shown in this example as three uniform, spaced, registered print rows 18 that are aligned with designated portions of the material 20.

It shall be appreciated that the size of the elements shown in the FIG. 2 are not to scale, and are provided for schematic illustrative purposes only to adequately convey how the methods of the invention can be achieved. In practice, the rollers may be quite large as compared to the width of the strip of metal stock, and therefore it is possible to apply thermal ink to much larger sized pieces of metal stock. Additionally, although only one ink is shown in the ink source 10, it is also contemplated with the method of the invention to use more than one ink. This can be achieved by sectioning or isolating the ink source 10 into a plurality of ink containers or wells, and each well having a pre-selected type of thermal ink. In some circumstances, it may be desirable to use more than one thermal ink on a beverage container to convey different temperature ranges to a consumer. Additionally, it is contemplated that application of the different inks can be applied to pre-selected and different portions of the container in order to convey temperature information. For example, the opening tab could include one or two inks, and the container sidewall could include one or more different inks in pre-selected patterns, but not a flood coating.

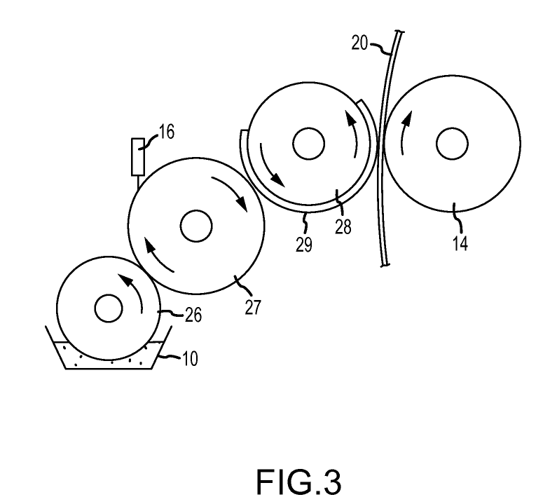

FIG. 2 is also intended to generally illustrate gravure printing. However, the method of the invention can be achieved with other types of printing processes. For example, referring to FIG. 3, another printing process that may achieve the method of the present invention includes flexography or letter press printing in which the image is transferred to the targeted material by a flexible relief plate as opposed to engravings. The relief plate has very small raised surfaces or protrusions that represent the particular pattern which is desired to be printed on the material.

This flexographic printing method may be achieved with a series of cylinders/rollers as shown in FIG. 3. More specifically, FIG. 3 illustrates a first ink supply roller or cylinder 26 whose purpose is to pick up and deliver a relatively heavy flow of ink from the ink source 10. The ink supply cylinder 26 contacts an anilox roll 27. Typically, the anilox roll 27 is a chrome or ceramic plated roll covered with a continuous series of very small engravings. For example, the number of engravings or cells may range from 100-1000 cells per linear inch. The purpose of the anilox roll 27 is to supply a very fine film of ink to printing plates 29 that are secured to a printing plate cylinder 28. As also shown, a reverse angled doctor blade can be used to wipe excess ink from the anilox roll 27. The printing plate cylinder 28 is installed between the anilox roll 27 and the impression cylinder or roller 14. The raised surfaces of the printing plates 29 pick up ink from the anilox roll and transfer it to the material 20 which is positioned between the impression cylinder 14 and printing plate cylinder 28. Typically, the impression cylinder 14 has a smooth and highly polished exposed surface that supports the material when it contacts the printing plates 29. Obviously, the speeds of rotation of the cylinders must match one another in order to advance the material 20 at a controlled, steady rate.

Another type of printing that is contemplated with the method of the invention also includes lithography printing. According to present methods of lithography, the image to be replicated on a targeted material is achieved by use of an image that is made of a polymer coating applied to a flexible plate, such as aluminum. The flexible metallic plate is then placed in contact with an image accepting surface, such as lithographic limestone or a metallic surface. This image accepting surface is slightly roughened or etched and divided into two regions. The first region is a hydrophilic region that accepts a film of water, and thereby repels inks which are typically oil-based. The other region is a hydrophobic region that repels water and therefore accepts the ink because the surface tension is greater on the image area in which the ink is found, and therefore this region remains dry. The image can be transferred directly from the image accepting surface, in which case the orientation of the image is reversed, or the image can be transferred by an offset element, that is, by transferring the image onto a flexible sheet of material such as rubber. Additionally, modern offset lithographic processes may also be used taking advantage of known photographic processes in which the printing plates have brushed or roughened texture surfaces covered with a photo-sensitive emulsion. A photographic negative of the desired image is placed in contact with the emulsion. The printing plate is then exposed to ultraviolet light, and after development, the emulsion shows a reverse of the negative image which is thus a duplicate of the original image. The printing plate can be made of material such as flexible aluminum, polyester, or milar, and is then affixed to a cylinder in the printing press. Dampening rollers apply water that covers the blank portions of the plate, but the water is repelled by the emulsion of the image area. Hydrophobic ink, which repels water, therefore only adheres to the emulsion of the image area. The hydrophobic ink is then applied by inking rollers to the material. The emulsion of the image area can be configured to correspond to precisely how a user wishes to apply the ink, and in the present case, a thermal ink to be applied to a component of a container, such as ink applied to create the registered print rows 18.

In addition to lithography or offset lithography, it is also contemplated that thermal inks can be applied by a screen printing process as well. As understood by those skilled in the art, screen printing is achieved by the transfer of ink or another printing medium through a mesh or screen that has been tightly stretched over a frame, and to which a stencil has been applied. The particular pattern of openings in the stencil determines the image that is transferred to the targeted material. The ink is forced through the screen, such as by a squeegee device, and the ink is therefore imparted onto the material according to the particular stencil image selected. As applied to the present invention, the particular configuration of the stencil can therefore be selected to avoid a flood coating and to only apply thermal ink to the pre-designated areas of the container components.

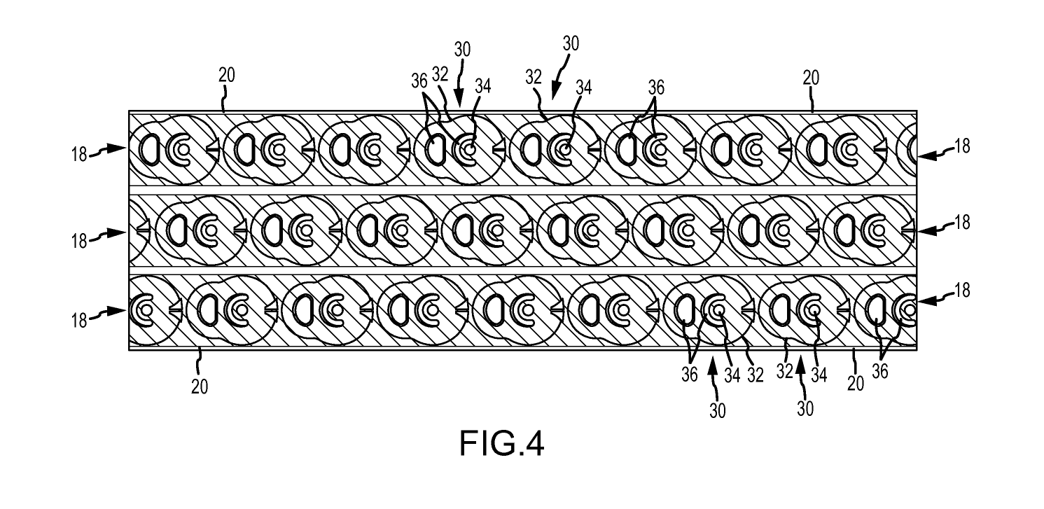

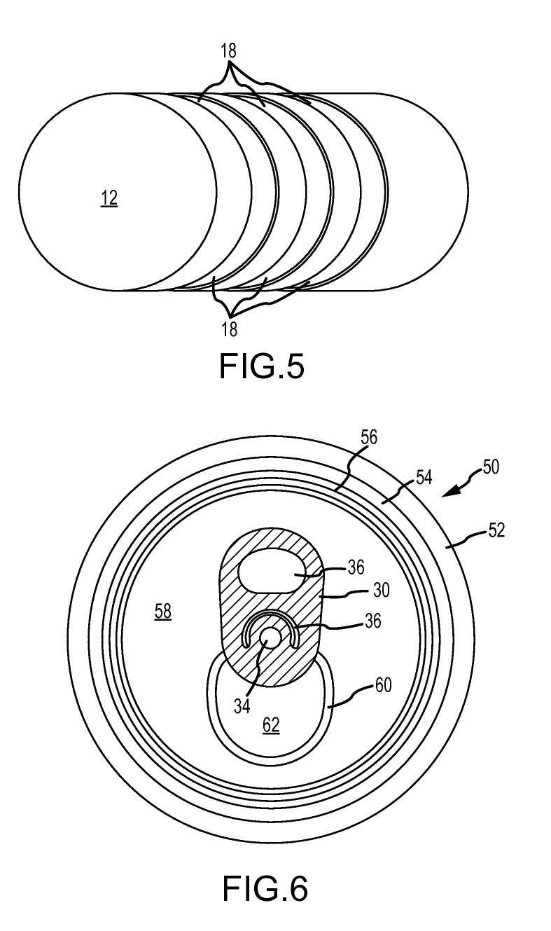

Now referring to FIG. 4, a strip of material 20 is illustrated in the form of a metallic stock which is used to form a plurality of opening tabs 30. The strip of material, also referred to herein as tab stock, has numerous score lines 32 that define the outer shape of the opening tabs 30. A plurality of openings or apertures is punched in the tab stock 20 and corresponds to other features of the opening tabs 30. For example, a plurality of hinge point openings 34 are provided that receive rivets attached to the container ends for securing the opening tabs to the ends of the containers. A plurality of other apertures 36 are also shown that correspond to other features of the opening tab 30. In the example of FIG. 4, there are three registered rows of printed thermal ink 18 that have been printed on the tab stock that correspond to pre-designated areas on the tab stock to receive the ink. These pre-designated areas are shown as continuous stripes or strips that cover the central portions of each of the opening tabs 30. As also illustrated in FIG. 4, the thermal ink can be applied in very finely defined areas on the tab stock. Therefore, it is apparent that, as compared to traditional flood coating, incorporation of registered print rows results in savings in the amount of ink used, and also provides selective and controllable areas in which the ink can be applied. Further, the various openings 34 and 36 that are punched in the tab stock are not filled with ink. Since the tab stock is of a known thickness, the distance between the impression roller and gravure cylinder can be calibrated such that only ink is applied to the exposed surface of the tab stock. Therefore, additional savings of thermal ink can be realized since the registered print rows do not result in ink being applied into the openings/apertures 34 and 36.

FIG. 4 provides just one example of how thermal ink could be applied to the opening tabs 30, and a user has the capability in accordance with the method of the invention to choose an almost limitless number of patterns that could be applied to not only the opening tabs, but also the container sidewalls, main panels of the container ends, and combinations thereof.

Since at least the exposed upper surface of an opening tab is not in direct contact with the container, it may experience greater susceptibility to ambient temperature conditions after the beverage has been removed from a controlled temperature environment (such as a refrigerator). Accordingly, as contemplated within the method of the invention, a type of ink can be selected that compensates for an average amount of time it may take for a consumer to view and open the container. For example, at a typical social event, a few of the beverages may be opened immediately after being removed from a refrigerated environment, but there may be a significant number of beverages that are not immediately consumed. Therefore, there can be extended time periods in which these containers may be exposed to the warmer ambient temperatures and therefore, the opening tabs may heat faster than the beverages within the containers. To address this possibility, it is contemplated that slower reacting thermal inks can be used in which the inks are slower to change color based on ambient temperature conditions. Also, multiple different types of inks could be used to provide a more accurate and continuing temperature indication, which could include a combination of faster and slower reacting thermal inks Finally, depending upon the particular construction and shape of the opening tabs used, and the manner in which the tabs are mounted on the container ends, data can be gathered to estimate how ambient temperature conditions could affect the upper surface temperature of the opening tabs, and types and patterns of inks could be selected accordingly.

In summary, applying thermal ink(s) to opening tabs results in a reduced amount of thermal ink used as opposed to flood coating a portion of the sidewall of the container. Yet, applying the thermal ink(s) to the opening tabs still provides an effective manner in which to present thermal inks to a consumer so the consumer can easily judge the temperature of the beverage based upon the color(s) of the thermal inks used.

Although the above described methods of the invention have been described with respect to various preferred forms or types of printing processes, it shall be understood that the invention may depart from the teachings of these preferred printing processes commensurate with the scope of the claims appended hereto.

what is claimed is:

1. A method of applying a thermal ink to a component of a container, said method comprising:
providing a strip of metallic material having formed thereon scored outlines corresponding to shapes of opening tabs for containers, and a plurality of apertures formed through the strip of material corresponding to apertures in the opening tabs;
providing a printing device including a first cylinder for transferring ink in a plurality of registered print rows corresponding to pre-designated areas on the strip of material;
operating the device to place a selected amount of thermal ink on the registered print rows;
further operating the device in which the strip of material is placed between the first cylinder containing the registered print rows containing ink, and a second cylinder that causes the strip of material to advance and to contact the first cylinder;
transferring the ink from the registered print rows on the first cylinder to the pre-designated areas on the strip of material, wherein the registered print rows align with rows of opening tabs formed on the strip of material.

2. A method, as claimed in claim 1, wherein:
said first cylinder is a gravure cylinder having etchings formed thereon corresponding to the plurality of registered print rows, and said thermal ink is transferred by gravure printing onto the strip of material.

3. A method, as claimed in claim 1, wherein:
said first cylinder is a printing plate cylinder having at least one printing plate secured thereto, and said thermal ink is transferred from said first cylinder to said strip of material by flexographic printing.

4. A method, as claimed in claim 1, wherein:
said registered print rows are arranged in three spaced print rows, each row being printed linearly along the strip of material.

5. A method, as claimed in claim 1, wherein:
the registered print rows have substantially parallel opposite side edges, and thermal ink is applied continuously between the opposite side edges to portions of the strip of material that are present and that have not been removed.

6. A method, as claimed in claim 1, wherein:
said method further includes the use of a doctor blade that communicates with said first cylinder for removing excess thermal ink from the first cylinder prior to application of the thermal ink onto the strip of material.

7. A method of applying a thermal ink to a component of a container, said method comprising:
providing a strip of metallic material having areas formed thereon corresponding to shapes of opening tabs for containers;
providing a printing device for transferring the thermal ink in a plurality of registered print rows corresponding to pre-designated areas on the strip of the material;
transferring the ink from the registered print rows to the pre-designated areas on the strip material, wherein the registered print rows align with the areas of the opening tabs on the strip of material, and said printing takes place by at least one of gravure printing or flexographic printing.

8. A method, as claimed in claim 7, wherein:
said registered print rows are arranged in a plurality of spaced print rows, each row being printed linearly along the strip of material.

9. A method, as claimed in claim 7, wherein:
the registered print rows have substantially parallel opposite side edges, and thermal ink is applied continuously between the opposite side edges to portions of the strip of material that are present.

10. A method of applying a thermal ink to a component of container, said method comprising:
providing a strip of metallic material having formed thereon areas that correspond to shapes of opening tabs for containers;
providing a printing device including a cylinder for transferring ink in a plurality of registered print rows corresponding to pre-designated areas on the strip of material;
operating the device to place a selected amount of thermal ink on the registered print rows;
further operating the device in which the strip of material is placed in contact with the cylinder containing the registered print rows, and transferring the ink from the registered print rows on the cylinder to the pre-designated areas on the strip of material.

11. A method, as claimed in claim 10, wherein:
a second cylinder of the printing device is provided and the strip of material is placed between the first and second cylinders for transferring the ink.

12. A method as claimed in claim 10, wherein transferring the ink is achieved by gravure printing.

13. A method, as claimed in claim 10, wherein:
transferring the ink is achieved by flexographic printing.

14. A method, as claimed in claim 10, wherein:
said registered print rows are arranged in a plurality of spaced print rows, each row being printed linearly along the strip of material.

15. A method, as claimed as claim 10, wherein:
the registered print rows have substantially parallel opposite side edges, and thermal ink is applied continuously between the opposite side edges to portions of the stripping material that are present.
